(19) United States
(12) Patent Application Publication
(10) Pub. No.: US 2010/0284242 A1
(43) Pub. Date: Nov. 11, 2010

(54) PROCESS-TECHNOLOGICAL SYSTEM FOR LABORATORY APPLICATIONS

(76) Inventors: Georg Konetzka, Augsburg (DE); Gerhard Kiederle, Wehringen (DE)

Correspondence Address: WINSTON & STRAWN LLP;PATENT DEPARTMENT, 1700 K STREET, N.W., WASHINGTON, DC, 20006, US

(21) Appl. No.: 12/768,648

(22) Filed: Apr. 27, 2010

(30) Foreign Application Priority Data
May 6, 2009 (DE) 102009019868.7-26

(51) Int. Cl. B01F 15/02; B01F 13/00

(52) U.S. Cl. 366/182.1; 366/342

(57) ABSTRACT

The invention concerns a process-technological system for the laboratory that has a frame which can be equipped with a variety of different processing machines and which can be used for both wet and dry processing. The system frame is equipped with an adapter to which the various machines can be connected, and the requisite media such as air and water needed to operate the machines are supplied through the adapter.

### BACKGROUND

The invention concerns a process-technological system for use in a laboratory wherein the system includes a frame which can be equipped with a variety of different processing machines and which can be used for both wet and dry processing.

When it comes to the development of innovative products, the high manufacturing costs and the high degree of potency usually means that only a small amount of the base material is available. This means that not only are mini machines necessary to develop these products and the associated manufacturing processes, but also complete process-technological systems for smallest samples where all the components are optimally coordinated to suit each other, e.g. a size reduction machine followed by a classifier and filtering unit. This makes a continuous process validation possible from the research phase to the production phase.

Laboratory machines are these days state of the art and are configured individually with the requisite peripheral units. Frequently, though, the components are not ideally matched to each other and take up a lot of space. They are therefore not easy to handle especially when it comes to cleaning, assembly and disassembly.

One disadvantage for laboratory workers is that individual machines with their own housings are configured into a system with peripheral units such as mixers, separators and a dedicated control cabinet. As an alternative, the product is charged to the individual machines one after the other. This approach complicates handling and cleaning procedures. Over and above this, it is not always possible to scale-up the results obtained to pilot or production scale.

Accordingly, improvements in the handling, sequential operation and scale up of such equipment is desirable and necessary, and these improvements are now provided by the present invention.

### SUMMARY OF THE INVENTION

The present invention now provides a solution which makes it possible to provide process-technological systems for the laboratory that are compact, universal in use and simple to handle. The invention relates to a design process-technological system that includes a frame equipped with an adapter which permits a variety of different machines to be fitted thereto, with requisite media such as air and water needed to operate the individual machines supplied through the adapter.

In particular, the invention relates to a process-technological system for laboratory applications wherein the system includes a frame, at least one processing machine, and an adapter located on the frame to which the machine(s) can be connected. One or more machines can be used. Advantageously, the adapter is operatively associated with at least air and water supplies and is configured and dimensioned for supplying at least air and water as desired as media needed to operate the machine(s) for either dry or wet processing of material.

The adapter typically includes bores through which the media flows to operate the respective machine(s). It is beneficial for the adapter to be designed to rotate into different positions. In a preferred embodiment, the adapter is a rotary union with ring conduits and is operatively associated with the machine(s) for rotation into position for filling, emptying, cleaning, installation or removal of the machine(s).

Typically, multiple machines are use and are associated with the adapter for receiving air or water. The machines generally include a mill, a classifier, a classifier mill, a mixer or combinations thereof and are designed to conduct continuous or discontinuous processing operations.

The system further comprises a control unit which is integrated into the frame. The control unit may be a microprocessor control unit. Alternatively, the system is equipped with a control unit with a machine recognition system.

The frame preferably has a closed design, and includes an operating panel. The closed design frame accommodates a control unit as well as other measuring, control and drive control instrumentation. The operating panel is typically equipped with a touch screen. Also, further system components may be connected to the frame using positive interlocking connections.

Another embodiment of the invention relates to a method of conducting laboratory applications, which comprises operating one of the systems disclosed herein to provide at least air and water as desired as media needed to operate on e or more machine(s) for either dry or wet processing of material.

The material is generally processed in samples ranging from 0.5 to 100 g and preferably from 1 to 10 g. Also, the samples can be processed to achieve a product yield of greater than 70% and preferably over 90%.

### BRIEF DESCRIPTION OF THE DRAWING FIGURES

Other details, features and advantages of the invention can be found in the following detailed description with reference to the associated drawings in which a preferred design example is represented and wherein:

FIG. 1 illustrates a system with wet mill, agitator vessel and agitator;

FIG. 2 illustrates a system with adapter and operating panel;

FIG. 3 is a top view of the system with partial section through the adapter; and

FIG. 4 illustrates a system with a classifier equipped with tray and retaining panel.

### DETAILED DESCRIPTION OF THE INVENTION

The invention-design process-technological system is especially designed for laboratory applications has a frame to which all necessary system components are fitted. In this way, the system configuration can be extremely compact. Furthermore, the system frame has an adapter to permit the connection of various processing machines. The system can thus be adapted to suit the different machines needed to fulfill the problem specification.

In operation, processing machines require media such as air to rinse gaps or as grinding air, or water as cooling water or sealing liquid for mechanical seals. These media are supplied to the machines via tubes. In the case of the invention-design system, the media are supplied centrally to the system, are subsequently split up and then supplied to the respective machine via the adapter located between the frame and the machine. This makes it possible to cut down on the number of tubes and hoses, the system is clearly laid out, easy to operate and also to clean.

Machines for either dry or wet processing can be employed in the system. This makes it possible to convert the system from a wet processing system to a dry processing system and vice versa to suit the specific application. The types of machines that can be employed are wet mills of various design, dry mills, granulators, classifier mills, air classifiers, mixers, mechano-chemical reactors and also compactors. Thus, powders or suspensions can be processed.

Either discontinuous or continuous processes can be performed with the invention-design process-technological system. The system can be extended at will to accommodate further components such as feed units, collectors, intermediate bins or pumps. The system components are housed in a protective casing in the form of a half-shell with operating panel that is easy to clean. These system components can be fixed to the frame by means of positive interlocking connections; alternatively, other components such as a filter, for example, can be fitted direct to the machines. Because the system components are fixed in place, short and clearly laid out connections can be effected between the components so that the system remains well organized and is simple to operate.

The machines are connected to the machine frame by means of an adapter. This adapter has bores through which the media, i.e., air and water, needed to operate the respective machine are supplied to the machine. The adapter can be designed as a rotary union with ring conduits. This makes it possible for the machine to be rotated into the right position for, e.g. filling, emptying, cleaning, installation or removal. Because the adapter is designed with assembly screws and set screws as well as a polygonal fitting element at the transition to the machine, it always accommodates the machine in the correct fitting position in a distortion-proof manner. This also rules out the possibility of mixing up the connections.

The frame of the system is in a closed design and accommodates the control unit. The control unit is preferably in the form of a microprocessor control unit. Control and measuring instruments are located in the enclosed zone with which the flow rate and pressure of rinsing air, grinding air or injector air as well as for the mechanical seal or the water for the cooling circuit can be set. The enclosed design of the frame means that the components are optimally protected, and to permit maintenance procedures, the rear panel can be removed.

In an invention-design variant, the control unit is equipped with a machine identification feature so that once the control unit has identified the fitted machine, it selects the requisite and for the most part pre-set parameters needed to control the machine. It forms the basis for comfortable and reliable system operation. The system can be operated using the operating panel with screen. This operating panel is embedded in the enclosed part of the frame.

The system, which can be fitted with a variety of different machines, is laid out for processing small samples. The amounts of feed material range between 0.5 and 100 g, preferably in the range between 1 and 10 g. The product yield is over 70%, and preferably over 90%.

The sophisticated design details of the invention-design system, which can be equipped with machines for both wet and dry processing, make it simple to operate. Individual machine parts can be removed and deposited on a tray and taken away for cleaning when necessary.

Furthermore, such a compact system makes it possible to run all the basic operations of a complex production process. The process developed in the laboratory can serve as the basis for a later validation of the manufacturing process for a production-scale system, because all the findings and results can be scaled-up absolutely true to scale.

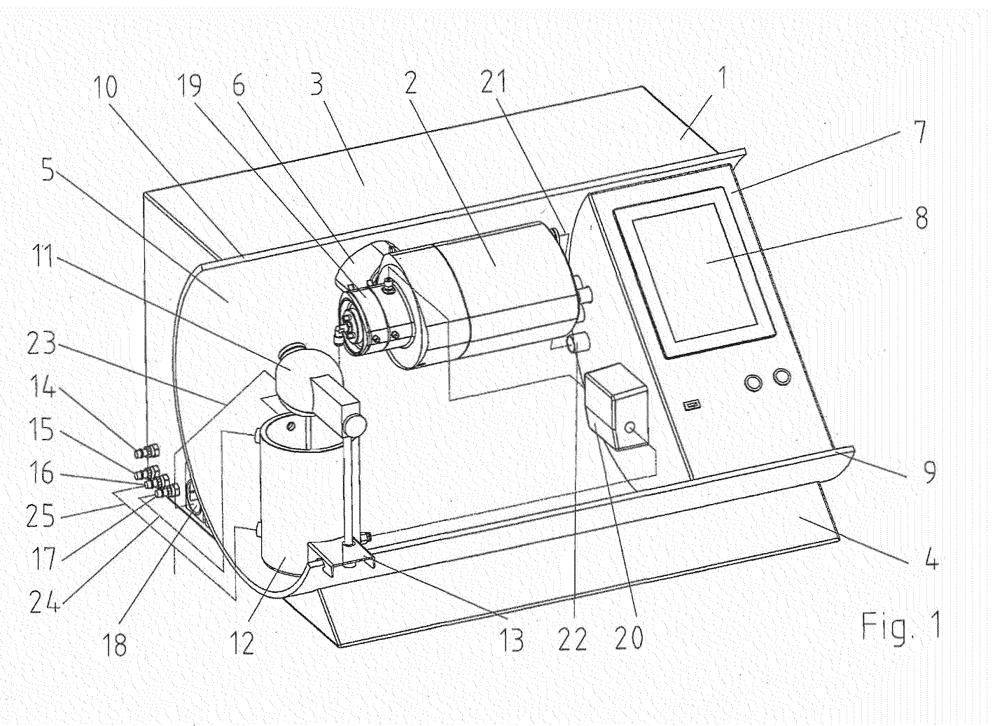

FIG. 1 shows the system (1) with a wet mill (2). The frame (3) consists of an enclosed base frame (4) and a half-shell (5). The processing machine, in this case the wet mill (2), is connected to the frame (3) by means of an adapter (6). The working area of the system is located in the half-shell (5). The adapter (6) pierces through the half-shell (5). The half-shell also accommodates the operating panel (7) with a viewing screen (8) at one end. This arrangement ensures that the working area is easy to clean. The edges (9, 10) of the half-shell (5) are used to fix system components (11, 12) in place using positive interlocking connections (13). In the event that the system is equipped with a wet mill, the system components including an agitator (11) and supply bin (12).

The frame (3) itself is in a closed design, has a removable rear panel that can be screwed in place and contains all the control and measuring instruments. The pneumatic, hydraulic and electric components such as pressure regulator, flowmeters, drive controller and control system microprocessor are also located here. The various components can be operated by the microprocessor through the control panel.

The connections (14, 15, 16, 17) for the working media such as water and compressed air as well as sockets (18) for peripherals such as the agitator (11) are located on the side panel of the frame (3). The central power supply for the system is located at the rear of the frame (3).

The wet mill (2) has a cooling jacket surrounding the grinding chamber (19) in order to remove any heat that develops during grinding. The seal between grinding chamber and drive unit is a mechanical seal. The internal circuits such as the cooling circuit for the grinding chamber (19) and sealing liquid circuit for the mechanical seal are effected by means of incoming and outgoing bores in the adapter and in the mill. The working medium—water in this case—is supplied to the system via connection (15). Inside the frame (3), the working medium is controlled by electric control and measuring instruments and is routed to the mill.

The process-technological parameters for the system (1) can be set or altered using the screen (8) integrated into the operating panel (7). The operating panel is also used to switch the control system over to another machine variant. Alternatively, the system can be equipped with a machine recognition system; the screen then displays the control parameters that are matched to the respective machine.

The following are controlled when operating the system (1) with a wet mill (2): the mill (2), the hose pump (20), the agitator (11), the mechanical seal and the cooling circuits. The hose pump (20) mounted on the side of the operating panel is employed if in closed-circuit mode, the feed material is circulated between mill (2) and supply bin (12). The mill motor is connected to the operating panel by means of a cable (21) with plug-in connection (22). The speed-controlled agitator (11) is connected to the socket (18) via a cable (23). The supply bin (12) can be cooled with the cooling water (24) exiting the outlet (17). The backflow from the supply bin (12) exits the system via ducting (25). The cooling water to cool the mill jacket and for the mechanical seal is supplied via the adapter (6) to the mill (2) and returned again, is routed to connection (16) and is then drained off together with the cooling water from the supply bin.

Alternatively, the laboratory system can be equipped with a dry processing machine such as a classifier or classifier mill. This is then also connected to the system by means of the adapter (6). The requisite gaseous working medium is supplied to the system via connection (14) and to the processing machine via the adapter (6).

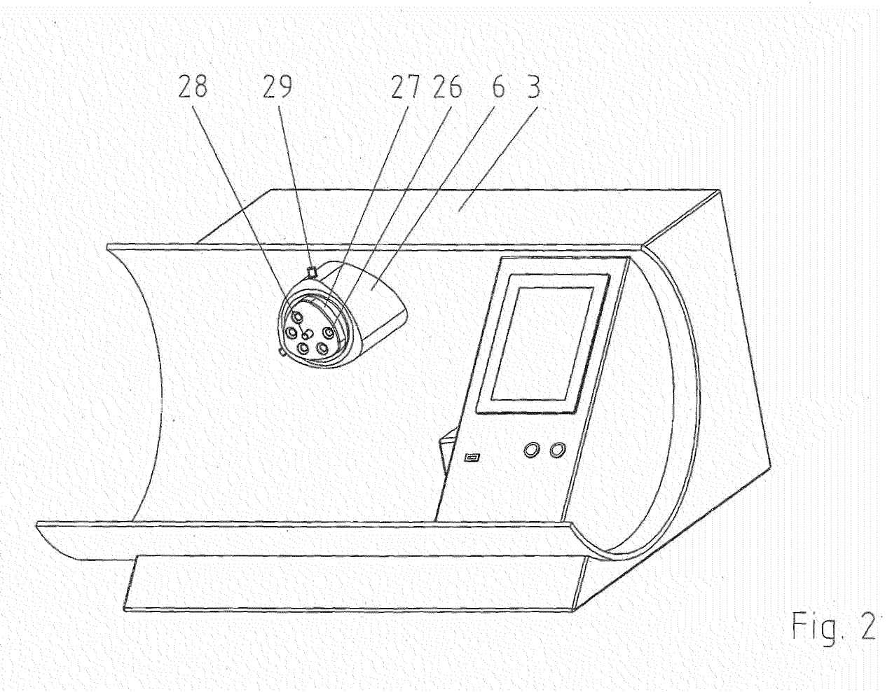

FIG. 2 shows the frame (3) and the adapter (6) where the different processing machines that can be selected are connected. The incoming and outgoing bores (26) are routed through the core of the adapter (6) and have a profile to accommodate a seal. These bores are used to supply the machine with the working media such as water and air and also to remove the same. The machine is mounted on the specially designed fitting element (27) and interlocked in place by means of the assembly screw (28) and set screw (29).

The adapter (6) can be designed such that the processing machine can be turned into different positions to facilitate emptying or mounting procedures.

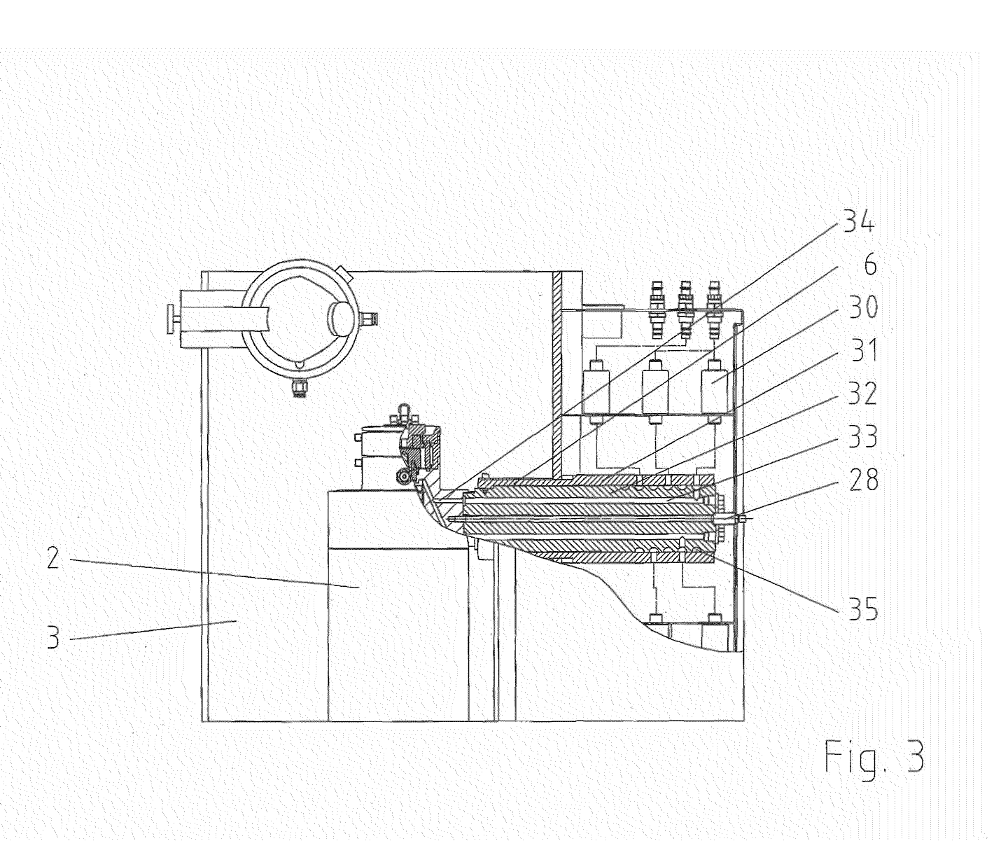

FIG. 3 shows a top view of part of the system (1) with a section through the adapter (6) and the frame. The pneumatic and hydraulic components (30) are shown in the area of the closed part of the frame. The process-technological machine is supported by the adapter (6) and is secured with the screw (28) and locked in place with a set screw. The adapter (6) consists of the metallic support (31) and the adapter core (32). Looking at the system from the top, the incoming and outgoing bores in the adapter (33) and the incoming and outgoing bores for the mill (34) as well as the ring conduit (35) of the rotary union are visible.

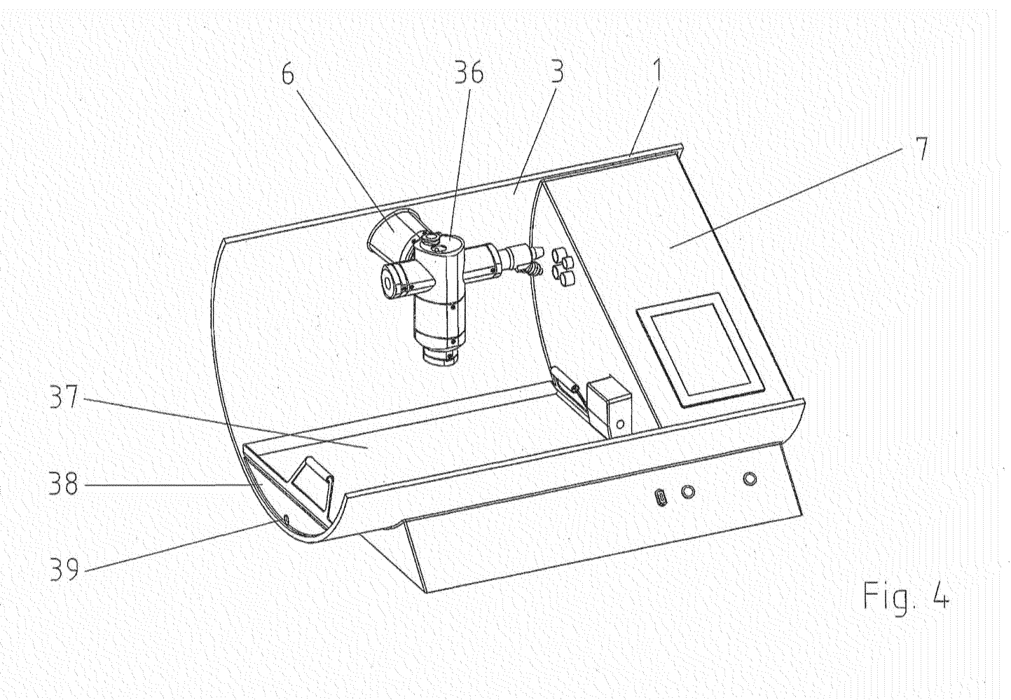

FIG. 4 shows a frame variant (3) with classifier (36) where the electric control unit is integrated mainly into the operating panel (7). Installation in this case is through the base plate of the frame.

A tray (37) can be placed in the half-shell to facilitate cleaning, assembly and disassembly of the machine. In order to keep any water, material and grinding media that discharge in wet processing mode inside the half-shell (5)—especially when cleaning the machines—a retaining panel (38) with sealable opening (39) is located at the open end of the half-shell to permit controlled removal from the half-shell. At the same time, the retaining panel (38) serves to accommodate the tray (37), which is extremely useful when dismantling the machines and transporting the component parts to the cleaning area.

What is claimed is:

1. A process-technological system for laboratory applications with the system including a frame, at least one processing machine, and an adapter located on the frame to which the machine(s) can be connected, wherein the adapter is operatively associated with at least air and water supplies and is configured and dimensioned for supplying at least air and water as desired as media needed to operate the machine(s) for either dry or wet processing.

2. The system of claim 1, wherein the adapter includes bores through which the media flows to operate the respective machine(s).

3. The system of claim 2, wherein the adapter is designed to rotate into different positions.

4. The system of claim 3, wherein the adapter is designed as a rotary union with ring conduits and is operatively associated with the machine(s) for rotation into position for filling, emptying, cleaning, installation or removal of the machine(s).

5. The system of claim 1, wherein at least two machines are used.

6. The system of claim 1, wherein the machines include a mill, a classifier, a classifier mill, a mixer or combinations thereof.

7. The system of claim 1, wherein the machine(s) conduct continuous or discontinuous processing operations.

8. The system of claim 1, which further comprises a control unit which is integrated into the frame.

9. The system of claim 1, which further comprises a microprocessor control unit which is integrated into the frame.

10. The system of claim 1, which further comprises a control unit with a machine recognition system.

11. The system of claim 1, wherein the frame has a closed design that accommodates a control unit as well as other measuring, control and drive control instrumentation and includes an operating panel.

12. The system of claim 11 wherein the operating panel is equipped with a touch screen.

13. The system of claim 1, wherein further system components are connected to the frame using positive interlocking connections.

14. A method of conducting laboratory applications, which comprises operating the system of claim 1 to provide at least air and water as desired as media needed to operate on e or more machine(s) for either dry or wet processing of material.

15. The method of claim 14, wherein the material is processed in samples ranging from 0.5 to 100 g.

16. The method of claim 15, wherein the samples are processed to achieve a product yield of greater than 70%.

17. The method of claim 14, wherein the material is processed in samples ranging from 1 to 10 g.

18. The method of claim 16, wherein the samples are processed to achieve a product yield of greater than 90%.
